(19) United States
(12) Patent Application Publication
(10) Pub. No.: US 2015/0310492 A1
(43) Pub. Date: Oct. 29, 2015

(54) Preference based anonymous mobile push targeted advertising based on time and proximity

(71) Applicants: Jeffrey Michael Zewin, Las Vegas, NV (US); Zubair Rafique, Las Vegas, NV (US)

(72) Inventors: Jeffrey Michael Zewin, Las Vegas, NV (US); Zubair Rafique, Las Vegas, NV (US)

(73) Assignee: Zatify Inc., Las Vegas, NV (US)

(21) Appl. No.: 14/261,428

(22) Filed: Apr. 25, 2014

(51) Int. Cl. G06Q 30/02; H04W 4/02

(52) U.S. Cl. CPC G06Q 30/0267; H04W 4/02; G06Q 30/0261; H04W 4/206

(57) ABSTRACT

A mobile marketing system for targeted advertising based on anonymous user input of preferences. The Zatify System utilizes technology that delivers mobile promotions based on location, timing and preferences. Users create a profile without the need to disclose any personal or identifying information; the profile is then used by marketing partners for targeted advertising. The Zatify program is installed on a user's smartphone and tracks the user's current location with the built in GPS of the device, enabling for the delivery of location aware targeted advertisements. Marketing partners creating promotions or ads enter criteria (which must be met) along with specific distance from the actual business location and the time of day—all specified criteria must be met in order for the user to receive the promotion.

This application claims the priority of the prior provisional application No. 61816639.

### BACKGROUND OF THE INVENTION

Advertising in the past was very generic, or vague. At best marketers had little information on who would be receiving or view their campaign. Recent advances in technology, particularly in Smartphone technology, have opened up a world of possibilities to quickly and easily target'those potential customers in multiple ways with great efficiency and little waste. Creation and production for marketing takes time and is costly. In the digital age these campaigns can be created and run much faster and cheaper. This invention will allow marketers the capability to select customer traits and demographics specific to their business. This invention will also allow marketers to cater to only those potential customers within a given proximity of the business location, as well as select what time of day to run that campaign so as to be most beneficial to the business. This in turn creates a very effective marketing campaign with little wasted revenue.

### SUMMARY OF THE INVENTION

Smartphones are carried by their owners at all times. Most people's phone is used by them and them alone. This creates a medium specific to a particular individual. This allows a user to install software on the device and create an account from which only a username and password are necessary. This makes the user profile fully anonymous such that users feel comfortable inputting preferences and having GPS track their location. Since the user carries the phone on their person, a smartphone with a Global Positioning System (“GPS”) active allows a program to know where the user is as well. User profiles are based on extensive category selections and personal demographics completed by the users. Combining the user profile with the GPS information from the smartphone, and the advertisers target audience selection criteria, allows the smartphone user to receive custom deals and promotions without the unwanted spamming common with the industry.

Created accounts also allow users to input areas of interest and volunteer personal data. By selecting these unique traits the user is informing the system as to what advertisements and promotions are of interest for that particular user. The system also has block capabilities for when unwanted ads or promos seep through. These two feature allow for better targeting of relevant offers. Marketing partners select to send out their advertisements or offers to users who match the specific traits most common to the advertisers business.

The software already installed on a GPS enabled device allows for the tracking of current location of the user. This is taken into account along with the input preferences to further narrow down and properly target the relevant users. Marketing partners select a proper proximity radius that will be most effective for their business. This greatly increases the probability for that advertisement or offer to be used.

The software allows for time scheduled and interval advertisements and offers. When a user with the correct preferences carrying a software enabled phone is within the physical proximity of the business during the time range specified by marketing partners, an advertisement or offer is then pushed to the users account.

Therefore, only when all criteria are met i.e. preference data, GPS proximity, and time range the system broadcasts the ad or promo to the account. This avoids irrelevant and annoying advertisements or promotions. This broadcast typically will be through mobile communication channel i.e. GPRS, 2G, 3G, 4G or WLAN or Wi-Fi signal.

User preference data stored in the cloud on servers and can be added or edited at any time by the user. The system also monitors user activity and auto adjusts preference data for the user based on their prior activity. If a user has not selected a particular category, yet has numerous times shown an interest in that field, the software will auto select that category.

Another embodiment of the invention is a client interface while registering the business, the client (on a GPS enabled device) registers the business location which sets longitude and latitude for exact reference later by our system. This information is then stored on a server for access when needed and for allowing businesses to be displayed in a graphical interface. After location information is stored the system also takes notes as to the time zone for which that business is located. This ensures that any and all time relevant campaigns are run to the proper time zone.

Another embodiment of invention is a method for quickly and easily creating a promotion using a client interface for either a mobile device or a computer. Available options will include setting desired budget amount, the title of the promotion, and upload photographs or other visual cues. Using this same interface, the client selects corresponding criteria relevant to their business or promotion. Finally, the client also selects a proper proximity radius for their registered business location for targeting users' GPS enabled device. This will be further comprised of functionality for selecting time interval or date interval to run the campaign. All input criteria must be met in order for the system to send the Push or promo to the user device. Marketers are charge when the promo or ad is pushed to a user account. Thus they only pay for those who end up seeing their promo or ad.

Another embodiment of invention is a client interface showing in real-time, the progress or results of a running, or previously run campaign. This allows for marketers to see the effectiveness of the campaign as well as review the costs.

The scope of this disclosure includes embodiments of the security cover applicable to securing other shapes and types of taps either in existence now or to be created. For example, embodiments of the security cover 200 within this disclosure would include one walled or sided security covers for circular taps, three walled or sided security covers for triangular taps, etc. Similarly, the sides do not need to be either parallel to one another or perpendicular to the distribution tap but could vary.

Whereas the disclosure has been shown and described in connection with the preferred embodiment thereof and a few variations, many modifications, substitutions and additions may be made which are within the intended broad scope of the disclosure.

ADVERTISEMENT BROADCAST METHOD:

1. A method for broadcast advertising to a mobile communication device, comprising the steps of:
Storing anonymous preference data of the communication device on the cloud; receiving by the communication device a broadcast advertisement containing advertisement data;
a) when broadcast advertisement matches all stored preferences/criteria selected by advertiser.
b) when a time slot indicated by the advertiser matches the time range on the mobile communication device.
c) when a communication device is within a certain proximity of the advertised business specified by the advertiser.

2. The method of claim 1,
a) wherein the acceptance data comprises preferences for accepting broadcast advertisements specified by a user of the communication device.
b) wherein the acceptance data comprises preferences for accepting broadcast advertisements specified by a user of the communication device and matches the time range set by the advertiser.
c) wherein the acceptance data comprises preferences for accepting broadcast advertisements specified by a user of the communication device and the communication device is within the specified proximity of the business/location as specified by the advertiser.
d) wherein the acceptance data comprises preferences for accepting broadcast advertisements specified by a user of the communication device, matches the time range set by the advertiser and the communication device is within the specified proximity of the business/location as specified by the advertiser.

3. The broadcast medium of claim 1,
a) wherein the broadcast advertisement is received by the communication device through a mobile wireless data communication channel (GPRS, 2G, 3G, or 4G)
b) wherein the broadcast advertisement is received by the communication device through a fixed wireless communication channel (WLAN or Wi-Fi).

4. The preference data of claim 1,
a) The method of claim 1, further comprising the step of modifying the acceptance data by owner of communication device.
b) The method of claim 1, further comprising the step of modifying the acceptance data by the system based on usage patterns of the owner of the communication device.
LOCATION REGISTRATION VIA GPS: 1. A method for registering the exact business location using a mobile GPS enabled device, comprising the steps of:
a) storing location data in latitude and longitude of the business on the cloud
b) associating this location data to the business or entity postal address
c) associating this GPS location data to a business or entity
d) displaying the business or entity in a graphical interface 2. The method of claim 1,
a) gps enabled mobile communication device
b) gps aware application displaying the mobile communication device latitude and longitude
c) application associating this location device latitude and longitude to a business or entity
d) application associating this location device latitude and longitude to a business or entity and on a graphical interface 3. The method of transmission of GPS location data,
a) wherein the registration data is transmitted to the cloud through a mobile wireless data communication channel (GPRS, 2G, 3G, or 4G)
b) wherein the registration data is transmitted to the cloud by the communication device through a fixed wireless communication channel (WLAN or Wi-Fi)
INSTANT PUSH ADVERTISING USING A MOBILE DEVICE: 1. A method for pushing custom mobile advertisements instantly from a registered device to registered devices, comprising the steps of:
a) Open a custom application on a mobile device to log in, wherein “logging in” refers to an individual entering a user id and password in a custom mobile application
b) Register device by logging in, wherein “Registered device or registered mobile device” refers to a user logging in using a user id and password
c) Selecting targeted audience (user id) preference data, wherein “Selecting targeted audience data” refers to indicating by check mark or other method available preference data set
d) Specifying targeted audience (user id) proximity to the advertised business for push to occur wherein the push would occur when the user id enters the specified radius
e) Selecting campaign timing when push should occur based on registered business location time wherein the push would occur at the specified time on the registered device
f) Allocating campaign budget for the push advertisements
g) Entering promotion name or title for the push advertisement
h) Entering promotion details for the push advertisement
i) Uploading promotion specific photo for the push advertisement
j) Reviewing summary of the promotion and submitting the promotion for instant or timed push to registered mobile devices 2. The method of claim 1,
a) Logging in refers to an individual entering a user id and password in a custom mobile application
b) Registered device or registered mobile device refers to a user logging in using a user id and password
c) Selecting targeted audience data refers to indicating by check mark or other method available preference data set
d) Specifying targeted audience proximity refers to all user id after being filtered through category preference selection that is within the specified proximity from the registered business location
e) Selecting a time for the push to occur refers to a specified time or interval when the promotion is pushed to a registered device taking into account claim 2d above
f) Specifying how many pushes will occur after all conditions are met based on a finite amount to be spent for the pushes
g) Customizing the push promotion with a specific title
h) Customizing the push promotion details with specific text
i) Uploading a custom photo for the push promotion
j) Reviewing by viewing the summary page and submitting the promotion 3. The method of transmission of the push promotion or advertisement,
a) wherein the push promotion or advertisement is transmitted through a mobile wireless data communication channel (GPRS, 2G, 3G, or 4G) by the registered mobile device
b) wherein the push promotion or advertisement is transmitted by the registered mobile device through a fixed wireless communication channel (WLAN or Wi-Fi).
